(19) United States
(12) Patent Application Publication
(10) Pub. No.: US 2007/0133450 A1
(43) Pub. Date: Jun. 14, 2007

(54) Broadcasting apparatus, radio terminal and communication system

(75) Inventor: Hiroyuki Hidaka, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION

(21) Appl. No.: 11/444,965

(22) Filed: May 31, 2006

(30) Foreign Application Priority Data
May 31, 2005 (JP) P.2005-160732

(51) Int. Cl. H04H 1/00

(52) U.S. Cl. 370/312; 370/390

(57) ABSTRACT

An access point obtains an incoming call monitoring timing at which each portable telephone accesses a BTS (base station) based on terminal identification information of all (or some) portable telephones managed by the access point. The access point assigns timings that do not overlap with the incoming call monitoring timing as broadcast timings.

This application claims foreign priority based on Japanese Patent application no. 2005-160732, filed May 31, 2005, the content of which is incorporated herein by reference in its entirety.

### BACKGROUND OF THE INVENTION

1. Field of the Invention

The present invention relates to a broadcasting apparatus, a radio terminal and a communication system for processing at least one of broadcast data and multicast data.

2. Description of the Related Art

In recent years, a radio terminal, whose representative example is a portable telephone, can use a voice system for performing radio communication of voice data for phone calls, as well as a packet system for performing radio communication of multimedia data having large data size, such as moving picture data, as packet data. The packet system employs a high-capacity frame having good transmitting efficiency as a transmission frame, and employs an encoding system having high error correction capability in a physical layer without assuring a transmission delay, which is considered to be important in the voice system. Thus, a high-speed and low-cost radio system is realized.

JP-T-2004-531937 proposes a system that performs multicast/broadcast services as a packet system capable of transmitting high-quality and large-capacity multimedia data while enhancing the transmitting efficiency of radio communication by sharing a single radio channel among a plurality of terminals.

As a radio terminal that can use both the voice system and the packet system, a so called hybrid terminal (may be simply called as a terminal) is proposed. The hybrid terminal performs a switching on a single RF (radio frequency) section to perform transmission/reception in the voice system or the packet system (single terminal), or switches a transmitter only in a case of performing the data transmission (dual terminal). Thus, there is no need to provide separate RF sections for both systems respectively, thereby realizing reduction in the cost of the terminal.

FIGS. 1A to 1C are timing charts showing an RF control operation of the hybrid terminal (terminal A) according to the voice system and the packet system.

In the voice system, a timing to notify each terminal of an incoming call is assigned based on terminal identification information which is unique to the terminal. For example, as shown in FIG. 1A, setting is made so that notification of incoming call to the terminal A is performed in a cycle of Tvoice. The terminal A performs location registration processing to notify a base station of own location, and after that, waits for the incoming call from the voice system. On the other hand, in the packet system, the terminal A receives control data that is notified per certain period. For example, as shown in FIG. 1C, the terminal A receives the control data in a cycle of Tpacket.

As a result, for example, at timings as shown in FIG. 1B, the terminal A monitors both the voice system and the packet system.

Such a hybrid terminal may fail to monitor the voice incoming call in the voice system since the hybrid terminal receives broadcast data transmitted over the packet system.

For example, in FIGS. 1A to 1C, the terminal A switches the RF section to the packet system at a timing S0 so as to receive the control data of the packet system. Following this, the terminal A sets the RF section to the packet system so as to receive the broadcast data transmitted over the packet system, and receives the broadcast data at timings S1 and S2 subsequent to the timing S0. When a monitoring timing of the voice incoming call for the terminal A (timing S3) is reached, the terminal A switches the RF section to the voice system so as to monitor the voice incoming call.

In this way, the terminal A repeatedly receives the control data, and the broadcast data over the packet system, and repeatedly monitors the incoming call in the voice system. The broadcast data is transmitted at the timing that does not overlap with that of transmission of the control data over the packet system, so that there may be a case where the timing of the transmission of the broadcast data does overlap with the timing of monitoring the incoming call of the voice system.

In this case, since the terminal A as the hybrid terminal includes only the single RF section, a problem arises that the monitoring of the voice incoming call or the reception of the broadcast data cannot be performed.

In the dual terminal that includes two receivers for receiving data respectively from the voice system and the packet system, and a single transmitter on which switching is performed according to the systems only in a case of performing the data transmission, one of the receivers is assigned to the voice system at the monitoring timing of the voice incoming call while diversity reception is performed so as to enhance reception sensitivity and quality of the broadcast data. Thus, the reception sensitivity of the broadcast data is deteriorated, which could increase a reception error rate, depending on radio wave conditions.

### SUMMARY OF THE INVENTION

The present invention has been made in view of the above circumstances, and provides a communication system and a broadcasting apparatus that allow a radio terminal to reliably access both voice data for voice communication and broadcast data, and also provides a radio terminal therefor.

In some implementations, a broadcasting apparatus comprises:

a request receiving section which receives at least one request for broadcast data from at least one radio terminal;

a timing calculating section which calculates a broadcast timing to transmit the broadcast data based on a communication timing of the radio terminal being obtained by the request; and

a transmitting section which transmits the broadcast data at the broadcast timing. Preferably, in the broadcasting apparatus of the invention,

in a case where the request receiving section receives the requests from the radio terminals, the timing calculating section calculates the broadcast timing that does not overlap with any one of the communication timings being obtained from the requests.

Preferably, in the broadcasting apparatus of the invention,

in a case where the request receiving section receives the requests from the radio terminals and the broadcast timing that does not overlap with any one of the communication timings being obtained from the requests cannot be calculated, the timing calculating section calculates the broadcast timing that overlaps with a few of the communication timings of the radio terminals.

Here, “the broadcast timing that overlaps with a few of the communication timings of the radio terminals” normally includes a meaning that the timing that overlaps with a minimum number of the communication timings of the radio terminals is assigned as the broadcast timing. In a case where several second timings exist as candidates, it is preferable that the timings are sequentially assigned as the broadcast timings of the broadcast data in ascending order of a number of the radio terminals performing the incoming call monitoring in that timing.

Preferably, the broadcasting apparatus of the invention further comprises an encoder which performs encoding on the broadcast data for error correction,

wherein in a case where the broadcast timing that overlaps with the few of the communication timings of the radio terminals is calculated as the broadcast timing, the encoder performs the encoding with a code having higher error correcting capability on the broadcast data to be transmitted at the broadcast timing, compared with the encoding on the broadcast data to be broadcasted at a timing that does not overlap with any one of the communication timings.

In some implementations, a radio terminal of the invention comprises:

a requesting section which requests a broadcasting apparatus to transmit broadcast data; and

a controller which selectively receives data for voice communication and the broadcast data by performing switching.

In some implementations, a communication system of the invention comprises;
a broadcasting apparatus including:
a request receiving section which receives at least one request for broadcast data from at least one radio terminal;
a timing calculating section which calculates a broadcast timing to transmit the broadcast data based on a communication timing of the radio terminal being obtained by the request; and
a transmitting section which transmits the broadcast data at the broadcast timing; and the radio terminal including;
a requesting section which requests the broadcasting apparatus to transmit the broadcast data; and
a controller which selectively receives data for voice communication and the broadcast data by performing switching.

According to the invention, a radio terminal can reliably access both the voice data for voice communication and the broadcast data.

### BRIEF DESCRIPTION OF THE DRAWINGS

FIGS. 1A to 1C are timing charts showing RF control operation of a related art hybrid terminal to support a voice system and a packet system.

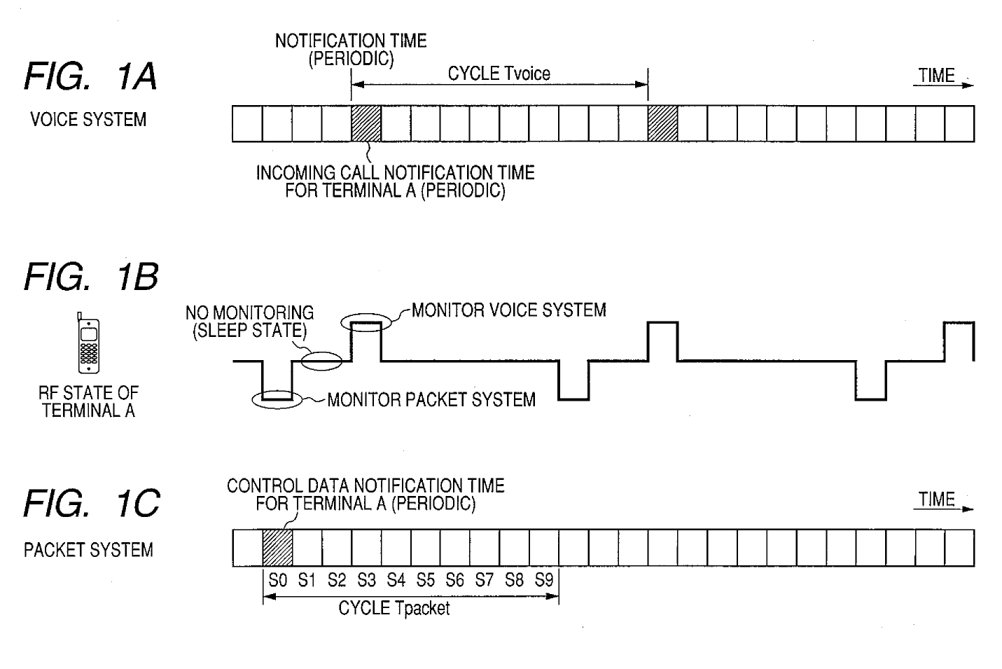

FIG. 2 shows an embodiment of a communication system according to the invention.

FIG. 3 is a block diagram showing a configuration of an access point in an embodiment.

FIGS. 4A and 4B are block diagrams showing configurations of a portable telephone in an embodiment.

FIG. 5 is a flow diagram showing a communication operation of the communication system according to an embodiment.

FIG. 6 is a flowchart showing an operation of the access point in an embodiment.

FIGS. 7A to 7G are timing charts showing the operation of the communication system according to an embodiment.

FIG. 8 is an example of an incoming call monitoring timing being assigned to each terminal.

### DESCRIPTION OF THE PREFERRED EMBODIMENTS

An embodiment of the invention will be described in relation to the attached drawings.

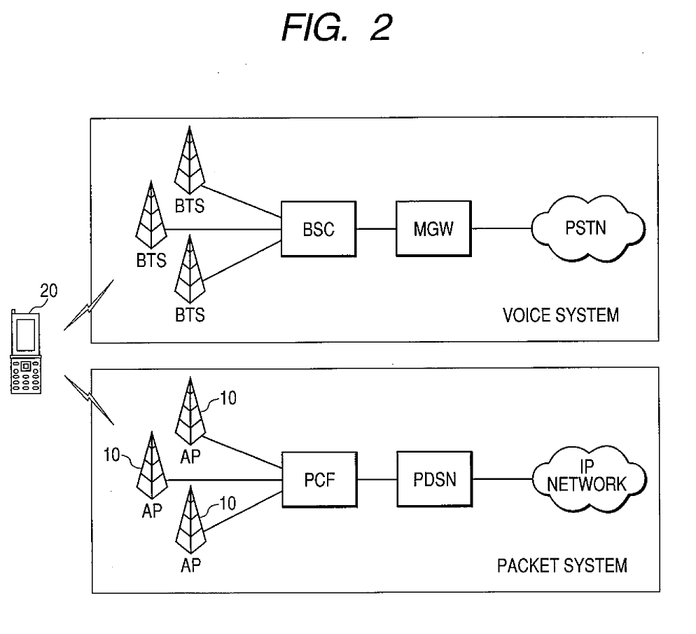

FIG. 2 is a diagram showing an embodiment of a communication system according to the invention.

The communication system according to this embodiment includes two systems, that is, a voice system and a packet system, for performing radio communication with a portable telephone (hereinafter, may be simply called as “terminal”) 20 as a radio terminal of the invention.

The voice system includes a BTS (base transceiver station) (hereinafter referred to as a base station) for transmitting/receiving radio signals, a BSC (base station controller) for controlling the base station and exchanging control data with the terminal, and an MGW (media gateway) used for connection to a PSTN (public switched telephone network). In the voice system, voice data for voice communication are processed.

The packet system includes an AP (access point 10; corresponding to a broadcasting apparatus of the invention) for transmitting/receiving the radio signals, a PCF (point coordination function) for controlling the AP and exchanging the control data with the terminal, and a PDSN (packet data service node) used for connection to an IP network. In the packet system, broadcast data (broadcast data according to the invention) is distributed to the portable telephone 20. In the following description, it is assumed that a broadcast system which does not limit destinations of data is the packet system. However, the invention is also applicable to a multicast system which limits the destinations of data.

Configuration and operation of the access point 10 and the portable telephone 20 are described below.

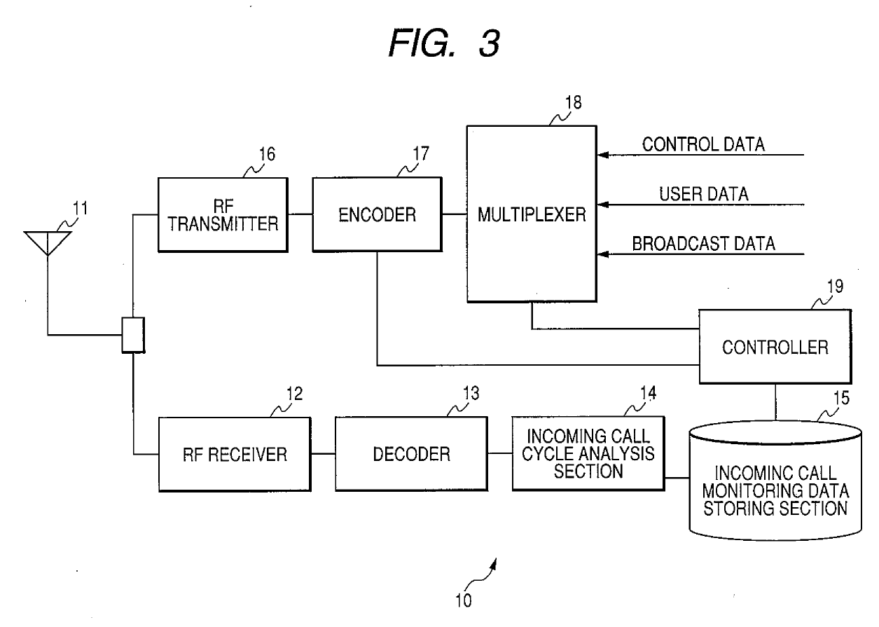

FIG. 3 is a block diagram showing the configuration of the access point 10.

As shown in FIG. 3, the access point 10 includes: an antenna 11, an RF receiver 12, a decoder 13, an incoming call cycle analysis section 14, an incoming call monitoring data storing section 15, an RF transmitter 16, an encoder 17, a multiplexer 18, and a controller 19.

In the access point 10, a radio wave transmitted from a portable telephone in an area managed by the access point 10 is input to the RF receiver 12 via the antenna 11. The RF receiver 12 detects the received radio wave.

The decoder 13 decodes the data processed by the RF receiver 12 in accordance with a radio communication system, and converts the data to digital data.

The incoming call cycle analysis section 14 analyzes terminal identification information transmitted from a plurality of portable telephones in the area managed by the access point 10, and records an incoming call monitoring timing as incoming call monitoring data into the incoming call monitoring data storing section 15. The incoming call monitoring timing is assigned for each portable telephone at the base station in the voice system. In the access point 10, the incoming call monitoring timing can be obtained based on the terminal identification information.

Receiving the control data, user data and the broadcast data from the PCF in a higher layer, the access point 10 supplies these data to the multiplexer 18.

The multiplexer 18 multiplexes the supplied control data, the supplied user data and the supplied broadcast data under the control of the controller 19. The multiplexed data is encoded by the encoder 17. This encoding process includes encoding in accordance with the radio communication system, and also encoding for error correction.

The RF transmitter 16 transmits via the antenna 11 the encoded data generated by the encoder 17 to the portable telephone in the area managed by the access point 10.

In this embodiment, the controller 19 assigns a transmission timing of the broadcast data based on the incoming call monitoring data of the plurality of portable telephones which are recorded in the incoming call monitoring data storing section 15, and controls the multiplexer 18so that the broadcast data is transmitted at that timing.

Next, the configuration of the portable telephone 20 will be described.

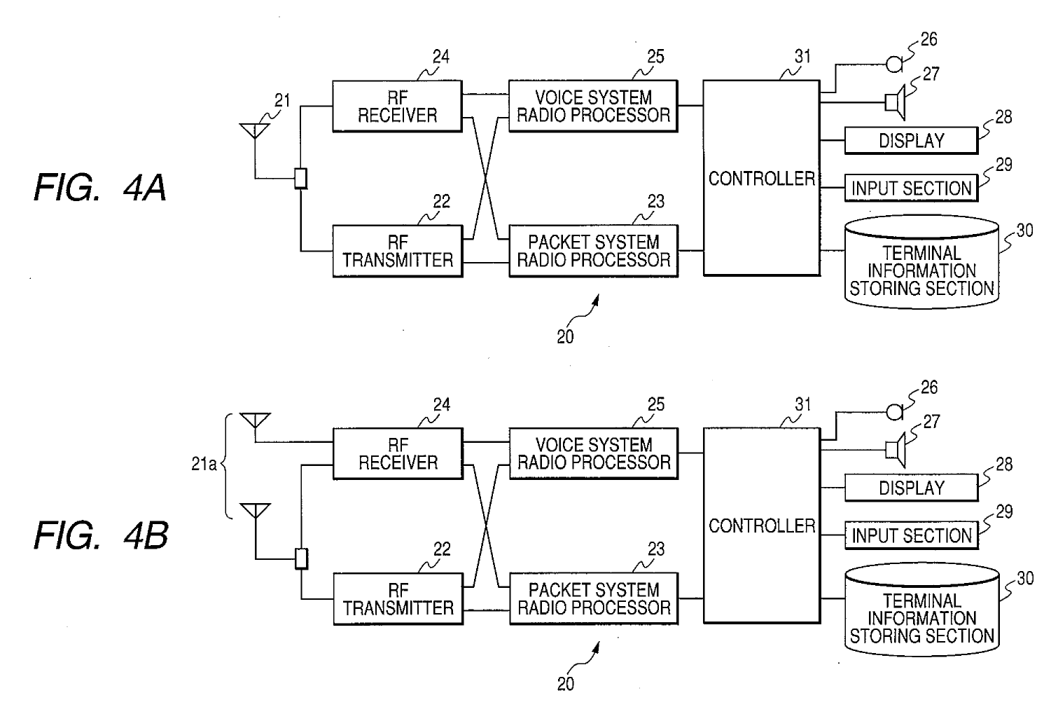

FIGS. 4A and 4B are block diagrams showing the configurations of the portable telephone 20. FIG. 4A shows a single terminal that does not perform diversity reception. FIG. 4B shows a dual terminal that performs the diversity reception.

As shown in FIG. 4A, the portable telephone 20 includes an antenna 21, an RF transmitter 22, a packet system radio processor 23, an RF receiver 24, a voice system radio processor 25, a microphone 26, a speaker 27, a display 28, an input section 29, a terminal information storing section 30, and a controller 31.

In the portable telephone 20, the radio wave received by the antenna 21 is input to the RF receiver 24. The RF receiver 24 detects the received radio wave, and extracts a baseband signal (receive signal).

The receive signal is supplied to the voice system radio processor 25 or the packet system radio processor 23 in accordance with the system for target communication. In other words, while communication is performed with the voice system, the receive signal is supplied to the voice system radio processor 25. While communication is performed with the packet system, the receive signal is supplied to the packet system radio processor 23.

For example, in the voice system radio processor 25, after a predetermined processing such as codec processing and filtering processing is performed on voice data for voice communication as the receive signal, the voice data is converted to analog data and amplified, and then output to the speaker 27 via the controller 31.

The packet system radio processor 23 demultiplexes the multiplexed data transmitted from the access point 10, and extracts the control data, the user data and the broadcast data.

Then, image data and voice data as the broadcast data are respectively output to the display 28 and the speaker 27 for playback.

When transmitting data, the controller 31 selects either the voice system radio processor 25 or the packet system radio processor 23 depending on user operation from the input section 29 or a control signal from an external device. The voice system radio processor 25 or the packet system radio processor 23 respectively performs a transmission process in accordance with each radio system.

For example, in the packet system radio processor 23, a request for the broadcast data of a desired content (hereinafter referred to as a broadcast request) is transmitted to the access point 10 via the RF transmitter 22 in accordance with the operation from the input section 29 or the like.

The packet system radio processor 23 references the terminal identification information recorded in the terminal information storing section 30, and transmits the terminal identification information to the access point 10 via the RF transmitter 22. The terminal identification information includes an ESN (electronic serial number), an IMSI (international mobile subscriber identity), a MIN (mobile identification number), and the like.

The voice system radio processor 25 periodically requests incoming call data to the base station at the incoming call monitoring timing assigned by the base station.

The dual terminal shown in FIG. 4B has a different antenna from that in the single terminal. That is, the dual terminal has an antenna 21a configured with two antennas. For example, the dual terminal performs antenna diversity reception when receiving the broadcast data in order to enhance the reception sensitivity.

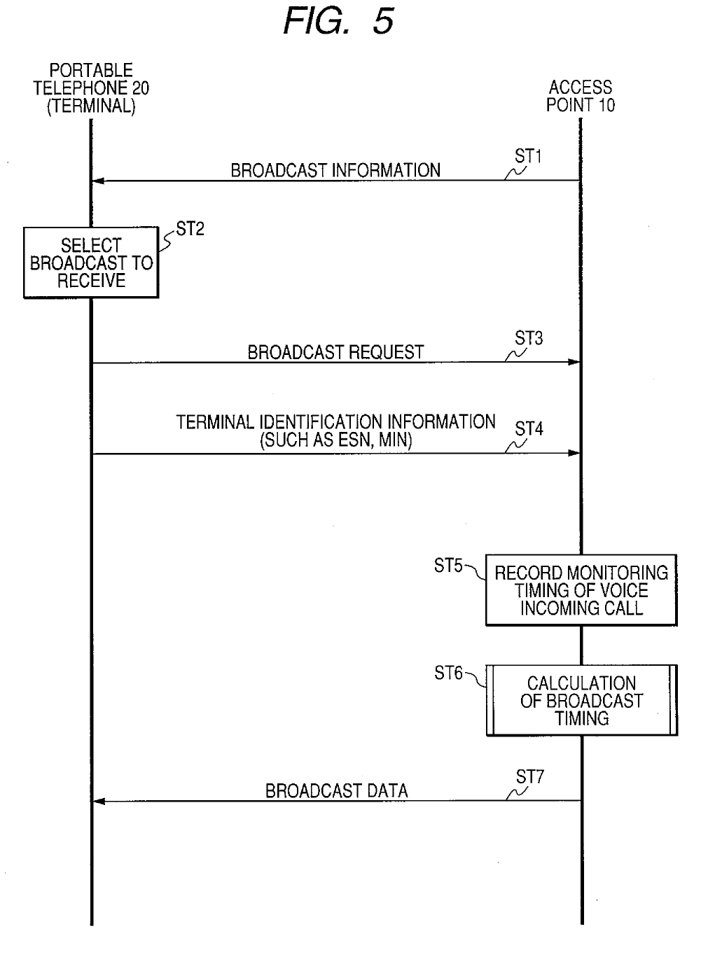

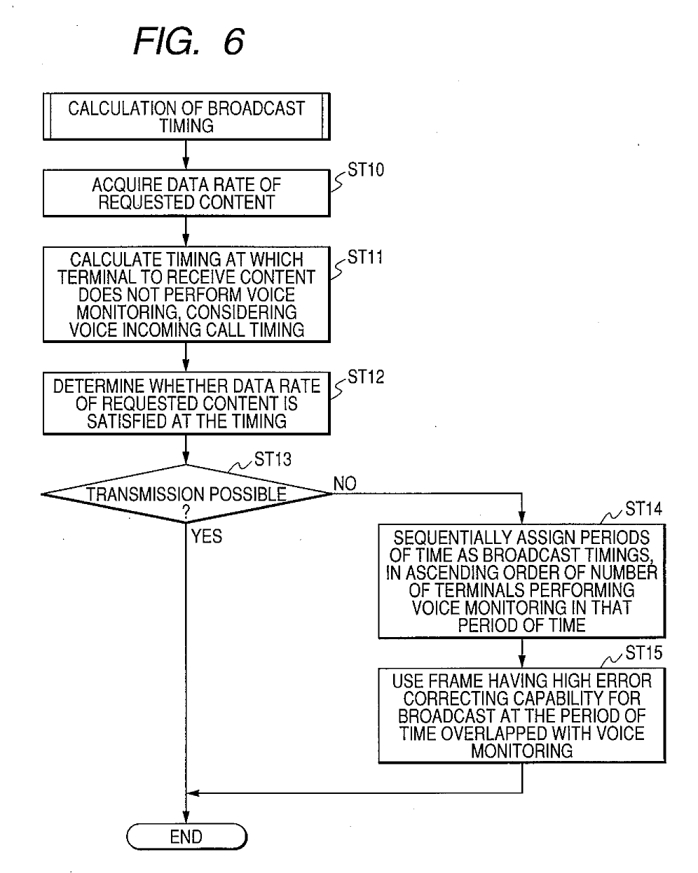

Next, operation of the communication system according to this embodiment will be described in relation to FIGS. 5 and 6.

FIG. 5 is a flow diagram showing the communication operation of the communication system according to this embodiment FIG. 6 is a flowchart showing a calculation process of broadcast timing by the access point 10.

The access point 10 transmits “broadcast information” including a list of broadcast data that can be distributed, to the portable telephone within the area (step ST1). The portable telephone 20 displays the list of broadcast data on the display 28 based on the “broadcast information”. Then, a desired broadcast service is selected via the input section 29 (step ST2).

As a result of selection, the “broadcast request” is transmitted to the access point 10 (step ST3). Also, the terminal identification information such as the ESN and the MIN is obtained from the terminal information storing section 30, and transmitted to the access point 10 (step ST4).

The access point 10 obtains an incoming call monitoring timing for voice communication based on the received terminal identification information, and records the incoming call monitoring timing into the incoming call monitoring data storing section 15 as incoming call monitoring data (step ST5). The access point 10 calculates the broadcast timing of the broadcast data considering the incoming call monitoring data (incoming call monitoring timing) of all the portable telephones within the area, that are recorded in the incoming call monitoring data storing section 15 (step ST6). Then, the access point 10 distributes the broadcast data to the portable telephone 20 with the calculated broadcast timing (step ST7).

Calculation of the broadcast timing in step ST6 in FIG. 5 is performed in accordance with the flowchart in FIG. 6.

In the access point 10, the controller 19 acquires a necessary data rate from the content for which the “broadcast request” is made (step ST10). Based on the incoming call monitoring data (data of incoming call monitoring timing) of all the portable telephones (terminals), that are recorded in the incoming call monitoring data storing section 15, each terminal to receive the content calculates the broadcast timings at which the voice monitoring is not performed, and the broadcast timings are assigned (step ST11).

In the case where the multicast data of which transmission destination is limited is handled instead of the broadcast data, only the incoming call monitoring data of the terminal as the transmission destination is considered in the calculation of the broadcast timing.

Then, it is determined whether the data rate of the requested content can be satisfied at the broadcast timings calculated in step ST11 (step ST12). In other words, content transmission time is calculated from the data volume of the requested content and the acquired data rate, so as to determine whether the transmission of the content is to be completed within a period where no terminals perform the voice monitoring.

In a case where the transmission of the content is to be completed within the period where no terminals perform the voice monitoring (step ST13), the broadcast timings as calculated in step ST11 are assigned and determined as the broadcast timings of the broadcast data.

In a case where the transmission of the content is not to be completed within the period where no terminals perform the voice monitoring (step ST13), timings (period of time) are sequentially assigned as the broadcast timings of the broadcast data in ascending order of a number of the terminals performing the incoming call monitoring in that timing (step ST14). This allows the dual terminal for performing the diversity reception so as to receive the broadcast data to suppress the occurrence S of the situation at minimum where the reception sensitivity deteriorates because of the interruption of the diversity reception for the voice incoming call monitoring. In the single terminal that switches the single RF section to receive the broadcast data, the occurrence of the reception error can be suppressed at minimum.

In a case where the incoming call monitoring timing overlaps with the broadcast timing, the controller 19 uses a frame having a higher error correcting capability for the broadcast data being transmitted at the overlapped timing (step ST15) This enhances the error correcting capability of the error that is accompanied by the deterioration of the reception sensitivity in the dual terminal, thus suppressing an increase in a rate of the reception error due to the interruption of the diversity reception. Also in the single terminal, it is possible to enhance the correcting capability of the reception error.

In the transmission of the broadcast data, an error correcting system by way of a data retransmission control such as ARQ (automatic repeat request) system cannot be performed even when the reception error occurs. Instead, packet transmission with error correction code by way of FEC (forward error correction) system is performed. For example in step ST15, a parity symbol length of the error correction code is increased.

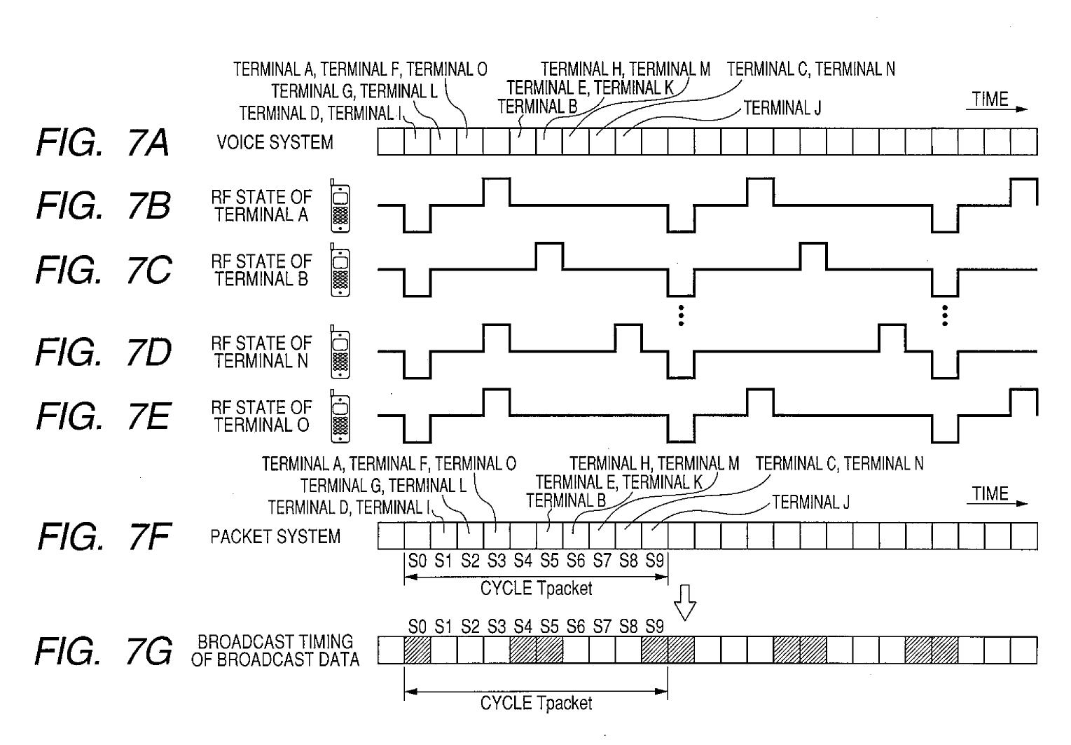

Next, a specific example of a method for calculating the broadcast timing will be described referring to FIGS. 7A to 7G. FIG. 7A shows a periodic incoming call monitoring timing assigned to each of the 15 terminals A to 0 in the voice system. FIGS. 7B to 7E show RF states of the terminals A to 0, where a downward pulse shows the monitoring timing of control information in the packet system, and an upward pulse shows the incoming call monitoring timing in the voice system.

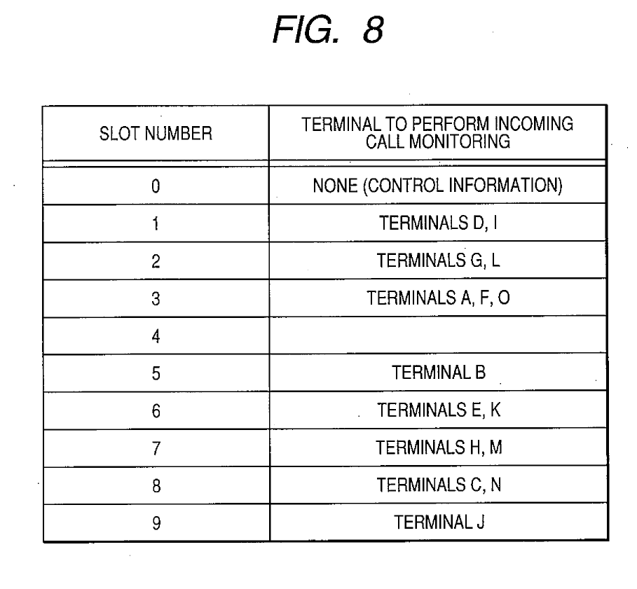

FIG. 7F shows the monitoring timing of the control information assigned in the packet system. The monitoring timings are assigned to the slot numbers 0 to 9 (timings S0 to S9) in a cycle of Tpacket, for example for each terminal as shown in FIG. 8.

FIG. 7G shows the calculated broadcast timing finally.

In the example shown in FIG. 7, the access point 10 at first assigns the timings S0 and S4 at which the 15 terminals A to 0 do not perform the incoming call monitoring, as the broadcast timings. Considering the data rate of the requested content, in a case where it is possible to transmit all the data of the requested content at the timings S0 and S4, the access point 10 determines the timings S0 and S4 as broadcast timings.

In a case where all the data of the content cannot be transmitted at the timings S0 and S4, the timings S5 and S9 at which only a small number of terminals are subject to the incoming call monitoring are further assigned as the broadcast timings. The parity symbol length of the broadcast data for error correction at the timings S5 and S9 is made longer than the broadcast data being transmitted at the timings S0 and S4.

With the broadcast timings calculated above, the broadcast data is periodically transmitted.

As mentioned above, according to the communication system of this embodiment, in the access point, the incoming call monitoring timing is obtained based on the terminal identification information of all (or some) portable telephones managed by the access point, and timings that do not overlap with the incoming call monitoring timing are assigned as the broadcast timings. As a result, each portable telephone can monitor the voice incoming call in the voice system without interrupting the reception of the broadcast data from the packet system.

In the case where the transmission timing of the broadcast data from the access point overlaps the voice incoming call monitoring timing of the base station, high error correction encoding is performed on the broadcast data to be transmitted to the portable telephone. Thus, the reception error rate in the portable telephone is reduced.

While an embodiment of the invention has been described referring to the drawings, specific configurations are not limited thereto but may include a design change or the like that falls within the scope of the invention.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A broadcasting apparatus comprising:
a request receiving section which receives at least one request for broadcast data from at least one radio terminal;
a timing calculating section which calculates a broadcast timing to transmit the broadcast data based on a communication timing of the radio terminal being obtained by the request; and
a transmitting section which transmits the broadcast data at the broadcast timing.

2. The broadcasting apparatus according to claim 1, wherein
in a case where the request receiving section receives the requests from the radio terminals, the timing calculating section calculates the broadcast timing that does not overlap with any one of the communication timings being obtained from the requests.

3. The broadcasting apparatus according to claim 1, wherein
in a case where the request receiving section receives the requests from the radio terminals and the broadcast timing that does not overlap with any one of the communication timings being obtained from the requests cannot be calculated, the timing calculating section calculates the broadcast timing that overlaps with a few of the communication timings of the radio terminals.

4. The broadcasting apparatus according to claim 3, further comprises:
an encoder which performs encoding on the broadcast data for error correction,
wherein in a case where the broadcast timing that overlaps with the few of the communication timings of the radio terminals is calculated as the broadcast timing, the encoder performs the encoding with a code having higher error correcting capability on the broadcast data to be transmitted at the broadcast timing, compared with the encoding on the broadcast data to be broadcasted at a timing that does not overlap with any one of the communication timings.

5. A radio terminal comprising:
a requesting section which requests a broadcasting apparatus to transmit broadcast data; and
a controller which selectively receives data for voice communication and the broadcast data by performing switching.

6. A communication system comprising:
a broadcasting apparatus including:
a request receiving section which receives at least one request for broadcast data from at least one radio terminal;
a timing calculating section which calculates a broadcast timing to transmit the broadcast data based on a communication timing of the radio terminal being obtained by the request; and
a transmitting section which transmits the broadcast data at the broadcast timing; and the radio terminal including:
a requesting section which requests the broadcasting apparatus to transmit the broadcast data; and
a controller which selectively receives data for voice communication and the broadcast data by performing switching.

7. The broadcasting apparatus according to claim 3, wherein the broadcast timing overlaps with a minimum number of the communication timings of the radio terminals.
